(19) United States
(12) Patent Application Publication
(10) Pub. No.: US 2007/0197556 A1
(43) Pub. Date: Aug. 23, 2007

(54) Fungicidal Mixtures

(76) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schofl, Bruhl (DE); Markus Gewehr, Kastellaun (DE)

Correspondence Address: BIRCH STEWART KOLASCH & BIRCH, PO BOX 747, FALLS CHURCH, VA, 22040-0747, US

(21) Appl. No.: 11/579,048

(22) PCT Filed: May 11, 2005
(86) PCT No.: PCT/EP05/05069

§ 371 Date: Oct. 30, 2006

(30) Foreign Application Priority Data
May 13, 2004 (DE) 10 2004 024 203.8

(51) Int. Cl. A01N 43/76; A01N 43/64; A01N 43/26; A01N 43/90; A01N 43/78; A01N 43/50

(52) U.S. Cl. 514/259.31; 514/439; 514/365; 514/374; 514/400; 514/383

(57) ABSTRACT

Fungicidal mixtures, comprising, as active components,
1) the triazolopyrimidine derivative of the formula I 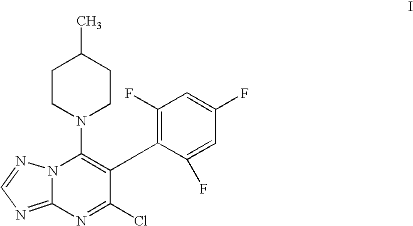 and
2) at least one biphenylamide of the formula II 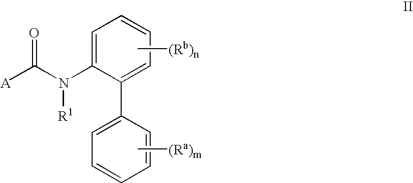 in which the variables are as defined below: A is oxathiinyl or 5-membered heteroaryl which contains one to four nitrogen atoms or one to three nitrogen atoms and/or one sulfur or oxygen atom, where A may be substituted according to the description;
R¹ is hydrogen, alkyl, alkylcarbonyl or a group A which is attached via carbonyl;
R^{a}, R^{b} are halogen, cyano, alkyl, haloalkyl, alkoxycarbonyl, alkoxy, haloalkoxy, alkylthio, alkylcarbonyl, formyl, alkylene or alkenylene which links two adjacent carbon atoms; m is 0, 1, 2, 3, 4 or 5; n is 0, 1 or 2; in a synergistically effective amount, methods for controlling harmful fungi using mixtures of the compound I with compound II and the use of the compound I with compounds II for preparing such mixtures, and also compositions comprising these mixtures.

The present invention relates to fungicidal mixtures, comprising, as active components,

1) the triazolopyrimidine derivative of the formula I 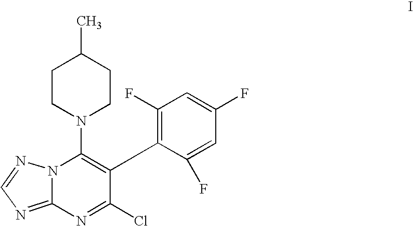
and

2) at least one biphenylamide of the formula II 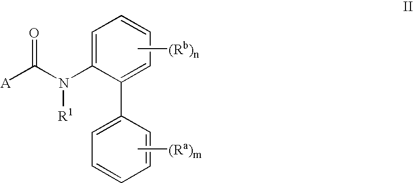
in which the variables are as defined below:
A is oxathiinyl or 5-membered heteroaryl which contains one to four nitrogen atoms or one to three nitrogen atoms and/or one sulfur or oxygen atom, where A may be substituted by one or two identical or different substitutents R;
R is halogen, cyano, C₁-C₄-alkyl, C₁-C₂-haloalkyl, C₁-C₄-alkoxy, C₁-C₄-alkylthio;
R¹ is hydrogen, C₁-C₄-alkyl, C₁-C₄-alkylcarbonyl or a group A which is attached via carbonyl;
R^{a}, R^{b} independently of one another are halogen, cyano, C₁-C₄-alkyl, C₁-C₄-halo-alkyl, C₁-C₆-alkoxycarbonyl, C₁-C₄-alkoxy, C₁-C₄-haloalkoxy, C₁-C₄-alkylthio, C₁-C₄-alkylcarbonyl, formyl, C₁-C₄-alkylene or C₂-C₄-alkenylene which links two adjacent carbon atoms;
m is 0, 1, 2, 3, 4 or 5, where the radicals R^{a} can be identical or different if n is greater than 1
n is 0, 1 or 2; where the radicals R^{b} can be identical or different if n is 2;
   in a synergistically effective amount.

Moreover, the invention relates to a method for controlling harmful fungi using mixtures of the compound I with a compound II and to the use of the compound I with compounds II for preparing such mixtures and compositions comprising these mixtures.

The compound 1,5-chloro-7-(4-methylpiperidin-1-yl)-6-(2,4,6-trifluorophenyl)[1,2,4]tri-azolo[1,5-a]pyrimidine, its preparation and its action against harmful fungi are known from the literature (WO 98/46607).

The compounds of the formula II, their preparation and their action against harmful fungi are likewise known from the literature (WO 01/42223; DE 198 40 322; JP 07/145,156; JP 2001/302 605; WO 03/066609; WO 03/066610; WO 03/099803; WO 03/099804; DE-A 102 46 959).

Mixtures of triazolopyrimidines with other active compounds are known in a general manner from EP-A 988 790 and U.S. Pat. No. 6,268,371.

It is an object of the present invention to provide, with a view to reducing the application rates and broadening the activity spectrum of the known compounds, mixtures which, at a reduced total amount of active compounds applied, have improved activity against harmful fungi (synergistic mixtures).

We have found that this object is achieved by the mixtures defined at the outset. Moreover, we have found that simultaneous, that is joint or separate, application of the compound I and the compound II or successive application of the compound I and the compound II allows better control of harmful fungi than is possible with the individual compounds (synergistic mixtures).

The mixtures of the compound I and the compound II or the simultaneous, that is joint or separate, use of the compound I and the compound II are distinguished by being outstandingly active against a broad spectrum of phytopathogenic fungi, in particular from the classes of the Ascomycetes, Deuteromycetes, Oomycetes and Basidiomycetes. They can be used in crop protection as foliar fungicides, as fungicides for seed dressing and as soil-acting fungicides.

They are particularly important in the control of a multitude of fungi on various cultivated plants, such as bananas, cotton, vegetable species (for example cucumbers, beans and cucurbits), barley, grass, oats, coffee, potatoes, corn, fruit species, rice, rye, soya, tomatoes, grapevines, wheat, ornamental plants, sugar cane and a large number of seeds.

They are advantageously suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necatoron grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria species on wheat, Botrytis cinerea on strawberries, vegetables, ornamental plants and grapevines, Mycosphaerella species on bananas, peanuts and cereals, Pseudo-cercosporella herpotrichoides on wheat and barley, Pyricularia oryzae on rice, Phakospora species on soya, Phytophthora infestans on potatoes and tomatoes, Pseudoperonospora species on cucurbits and hops, Plasmopara viticola on grapevines, Alternaria species on fruit and vegetables and also Fusarium and Verticillium species.

They are particularly suitable for controlling harmful fungi from the class of the Oomycetes. Moreover, they can be used in the protection of materials (e.g. the protection of wood), for example against Paecilomyces variotii.

The compound I and the compound II can be applied simultaneously, jointly or separately, or in succession, the sequence, in the case of separate application, generally not having any effect on the result of the control measures.

In the definitions of the symbols given for formula II collective terms were used which are representative for the following substitutents:

halogen: fluorine, chlorine, bromine and iodine;

alkyl: saturated straight-chain or branched hydrocarbon radicals having 1 to 4 carbon atoms, for example C₁-C₄-alkyl, such as methyl, ethyl, propyl, 1-methylethyl, butyl, 1-methylpropyl, 2-methylpropyl, 1,1-dimethylethyl;

haloalkyl: straight-chain or branched alkyl groups having 1 or 2 carbon atoms (as mentioned above), where some or all of the hydrogen atoms in these groups may be replaced by halogen atoms as mentioned above: in particular C₁-C₂-haloalkyl, such as chloromethyl, bromomethyl, dichloromethyl, trichloromethyl, fluoromethyl, difluoro-methyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-tri-fluoroethyl, 2-chloro-2-fluoroethyl, 2-chloro-2,2-difluoroethyl, 2,2-dichloro-2-fluoroethyl, 2,2,2-trichloroethyl, pentafluoroethyl or 1,1,1-trifluoroprop-2-yl.

5-membered heteroaryl which contains one to four nitrogen atoms or one to three nitrogen atoms and/or one sulfur or oxygen atom: 5-membered heteroaryl groups which, in addition to carbon atoms, may contain one to four nitrogen atoms or one to three nitrogen atoms and one sulfur or oxygen atom as ring members, for example 2-furyl, 3-furyl, 2-thienyl, 3-thienyl, 2-pyrrolyl, 3-pyrrolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, and 1,3,4-triazol-2-yl;

alkylene: divalent unbranched chains of 1 to 4 CH₂ groups, for example CH₂, CH₂CH₂, CH₂CH₂CH₂ and CH₂CH₂CH₂CH₂;

alkenylene: divalent unbranched chains of 2 to 4 carbon atoms and one or two double bonds, for example CH═CH, CH═CHCH₂, CH═CH₂CH₂CH₂, CH₂CH═CH₂CH₂ and CH═CHCH═CH.

The formula II represents in particular compounds in which the index n is 1 or 2, preferably 1.

In one embodiment of the mixtures according to the invention, the biphenylamides correspond to the formula IIA:

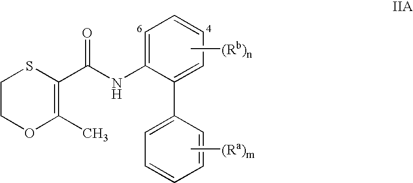

in which (R^{a})ₘ and (R^{b})ₙ are as defined for formula II. Preference is given to compounds of the formula IIA in which n is 0 or 1, where, if n is 1, the group R^{b} is advantageously located in the 4-position. Particular preference is given to compounds IIA in which n=0. In addition, preference is also given to compounds of the formula IIA in which m is 1 or 2, where one substitutent is advantageously located in the para-position.

R^{a} is preferably selected from the following groups: halogen, such as fluorine, chlorine, bromine; cyano; C₁-C₄-alkyl, such as methyl; C₁-C₄-haloalkyl, such as trifluoromethyl; C₁-C₄-alkoxy, such as methoxy; C₁-C₄-haloalkoxy, such as trifluoromethoxy; C₁-C₄-alkylthio, such as methylthio.

Particular preference is given to the following compounds of the formula IIA:

| No. | (R^{a})ₘ | (R^{b})ₙ |
|---|---|---|
| IIA-1 | 2-F,4-Cl | — |
| IIA-2 | 4-CF₃ | — |
| IIA-3 | 4-OCF₃ | — |
| IIA-4 | 4-SCH₃ | — |
| IIA-5 | 4-Br | — |
| IIA-6 | 3,4-Cl₂ | — |
| IIA-7 | 2,4-Cl₂ | — |
| IIA-8 | 2-CH₃,4-Cl | — |
| IIA-9 | 3-F,4-Cl | — |
| IIA-10 | 3-Cl,4-F | — |
| IIA-11 | 3,5-Cl₂ | — |
| IIA-12 | 3,4-F₂ | — |
| IIA-13 | 3-CF₃,4-Cl, | — |
| IIA-14 | 3,4-Cl₂ | 4-F |
| IIA-15 | 3-CH₃,4-Cl | — |
| IIA-16 | 3,4-Cl₂ | 6-F |
| IIA-17 | 4-Cl | — |
| IIA-18 | 2,4-F₂ | — |
| IIA-19 | 4-CN | — |
| IIA-20 | 3-F,4-CF₃ | — |
| IIA-21 | 3-CH₃,4-F | — |
| IIA-22 | 3-Cl,4-CH₃ | — |
| IIA-23 | 2-F,4-CH₃ | — |
| IIA-24 | 3,5-F₂ | — |
| IIA-25 | 3-Cl,4-CF₃ | — |

In a further preferred embodiment of the mixtures according to the invention, the biphenylamides correspond to the formula IIB: 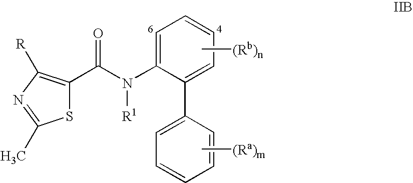
in which the variables are as defined for formula II. Preference is given to compounds of the formula IIB in which R is halomethyl, in particular difluoromethyl or trifluoromethyl.

In addition, preference is given to compounds IIB in which R¹ is hydrogen, methyl, acetyl or 2-methyl-4-difluoromethylthiazol-5-ylcarbonyl, in particular hydrogen.

Preference is likewise given to compounds IIB in which R^{a} is halogen, cyano, methyl, methoxy, halomethyl, such as trifluoromethyl, or halomethoxy, such as trifluoromethoxy.

In addition, preference is given to compounds IIB in which R^{b} is halogen.

Furthermore, preference is given to compounds IIB in which n=0.

In addition, preference is given to compounds IIB in which m is 1 or 2, where one substitutent is advantageously located in the para-position.

Particular preference is given to the following compounds of the formula IIB:

| No. | R | R¹ | (R^{a})ₘ |
|---|---|---|---|
| IIB-1 | CHF₂ | C(═O)CH₃ | 4-Br |
| IIB-2 | CHF₂ | CH₃ | 4-Cl |
| IIB-3 | CHF₂ | 2-methyl-4- | 3-CH₃,4-Cl |
| | | difluoromethylthiazol- | |
| | | 5-ylcarbonyl | |
| IIB-4 | CHF₂ | 2-methyl-4- | 3,5-Cl₂ |
| | | difluoromethylthiazol- | |
| | | 5-ylcarbonyl | |
| IIB-5 | CHF₂ | 2-methyl-4- | 4-Cl |
| | | difluoromethylthiazol- | |
| | | 5-ylcarbonyl | |
| IIB-6 | CHF₂ | CH₃ | 4-Br |
| IIB-7 | CHF₂ | CH₃ | 4-F |
| IIB-8 | CHF₂ | C(═O)CH₃ | 4-F |
| IIB-9 | CHF₂ | H | 3-Cl,4-F |
| IIB-10 | CHF₂ | H | 4-Br |
| IIB-11 | CHF₂ | H | 4-CF₃ |
| IIB-12 | CHF₂ | H | 3-Cl |
| IIB-13 | CHF₂ | H | 4-OCF₃ |
| IIB-14 | CHF₂ | H | 4-SCH₃ |
| IIB-15 | CHF₂ | H | 4-F |
| IIB-16 | CHF₂ | H | 3,4-Cl₂ |
| IIB-17 | CHF₂ | H | 2,4-Cl₂ |
| IIB-18 | CHF₂ | H | 2-CH₃,4-Cl |
| IIB-19 | CHF₂ | H | 3-F,4-Cl |
| IIB-20 | CHF₂ | H | 3-Cl,4-CH₃ |
| IIB-21 | CHF₂ | H | 2-F,4-Cl |
| IIB-22 | CHF₂ | H | 3-F,5-Cl |
| IIB-23 | CHF₂ | H | 4-Br |
| IIB-24 | CHF₂ | H | 3-CH₃,4-Cl |
| IIB-25 | CHF₂ | H | 3,5-Cl₂ |
| IIB-26 | CHF₂ | H | 3,5-F₂ |
| IIB-27 | CHF₂ | H | 3-CF₃,4-Cl |
| IIB-28 | CHF₂ | H | 3,4-F₂ |
| IIB-29 | CHF₂ | H | 4-Cl |
| IIB-30 | CHF₂ | H | 3-F,4-Br |
| IIB-31 | CHF₂ | H | 3-F,4-CF₃ |
| IIB-32 | CHF₂ | H | 4-F |
| IIB-33 | CHF₂ | H | 4-CN |
| IIB-34 | CHF₂ | H | — |
| IIB-35 | CF₃ | H | 3-Cl,4-F |
| IIB-36 | CF₃ | H | 3,4-CH═CHCH═CH |
| IIB-37 | CF₃ | H | 3,4-F₂ |
| IIB-38 | CF₃ | H | 3,5-F₂ |
| IIB-39 | CF₃ | H | 2,4-F₂ |
| IIB-40 | CF₃ | H | 3-F,4-Cl |
| IIB-41 | CF₃ | H | 3,4-Cl₂ |
| IIB-42 | CF₃ | H | 3-CF₃,4-F |
| IIB-43 | CF₃ | H | 3-CH₃,4-Cl |
| IIB-44 | CF₃ | H | 3-CF₃,4-Cl |
| IIB-45 | CF₃ | H | 3-CF₃,4-CH₃ |
| IIB-46 | CF₃ | H | 3-CF₃,4-OCF₃ |
| IIB-47 | CF₃ | H | 3,5-Cl₂ |
| IIB-48 | CF₃ | H | 3-F,4-OCF₃ |
| IIB-49 | CF₃ | H | 2-CH₃,4-Cl |
| IIB-50 | CF₃ | H | 2,4-Cl₂ |
| IIB-51 | CF₃ | H | 3-Cl,4-CH₃ |
| IIB-52 | CF₃ | H | 2-F,4-Cl |
| IIB-53 | CF₃ | H | 3-F,5-Cl |
| IIB-54 | CF₃ | H | 2-F,4-Br |
| IIB-55 | CF₃ | H | 3-F,4-Br |
| IIB-56 | CF₃ | H | 3-Cl,4-Br |
| IIB-57 | CF₃ | H | 2-F,4-I |
| IIB-58 | CF₃ | H | 3-F,4-CF₃ |

In a further preferred embodiment of the mixtures according to the invention, the biphenylamides correspond to the formula IIC: 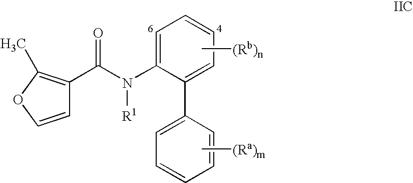
in which the variables are as defined for formula II.

The preferred embodiments of the substitutents of the compounds IIC correspond to those of the compounds IIB, where R¹ is preferably hydrogen, methyl, acetyl or 2-methylfuran-3-ylcarbonyl, in particular hydrogen.

Particular preference is given to the following compounds IIC (R¹═H; n=0):

| No. | (R^{a})ₘ |
|---|---|
| IIC-1 | 2-F,4-Cl |
| IIC-2 | 4-Br |
| IIC-3 | 4-CF₃ |
| IIC-4 | 3-Cl |
| IIC-5 | 4-OCF₃ |
| IIC-6 | 4-SCH₃ |
| IIC-7 | 4-F |
| IIC-8 | 3,4-F₂ |
| IIC-9 | 3-F,4-Cl |
| IIC-10 | 3-cl,4-F |
| IIC-11 | 3-F,4-OCF₃ |
| IIC-12 | 3-CF₃,4-Cl |
| IIC-13 | 3-CF₃,4-CH₃ |
| IIC-14 | 3-CF₃,4-OCF₃ |
| IIC-15 | 3,4-Cl₂ |
| IIC-16 | 3,5-Cl₂ |
| IIC-17 | 3-CF₃,4-F |
| IIC-18 | 3-CH₃,4-Cl |
| IIC-19 | 2,4-Cl₂ |
| IIC-20 | 2-CH₃,4-Cl |
| IIC-21 | 4-Cl |
| IIC-22 | 4-CN |
| IIC-23 | 3-F,4-CF₃ |
| IIC-24 | 3,5-F₂ |
| IIC-25 | 3-CH₃,4-F |
| IIC-26 | 3-F,4-CH₃ |
| IIC-27 | 3-Cl,4-CH₃ |
| IIC-28 | 2-F,4-CH₃ |
| IIC-29 | 3,Cl,4-CF₃ |

In a further preferred embodiment of the mixtures according to the invention, the biphenylamides correspond to the formula IID: 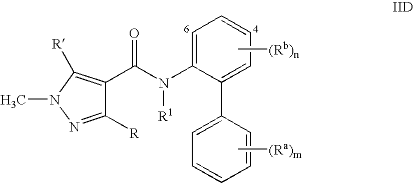
in which the variables are as defined for formula II and R¹ corresponds to a group R.

Preference is given to compounds IID in which R is halogen, in particular fluorine, methyl or halomethyl, such as trifluoromethyl.

In addition, preference is given to compounds IID in which R¹ is preferably hydrogen or methyl, in particular hydrogen.

The preferred embodiments of the formula IID of (R^{a})ₘ and (R^{b})ₙ correspond to those of formula IIB.

Particular preference is given to the following compounds IID (R¹═H; n=0):

| No. | R | R′ | (R^{a})ₘ |
|---|---|---|---|
| IID-1 | CF₃ | H | 4-Cl |
| IID-2 | CF₃ | H | 4-F |
| IID-3 | CH₃ | H | 4-Cl |
| IID-4 | CH₃ | H | 4-F |
| IID-5 | CF₃ | F | 4-Cl |
| IID-6 | CF₃ | F | 4-F |
| IID-7 | CH₃ | F | 4-Cl |
| IID-8 | CH₃ | F | 4-F |

When preparing the mixtures, it is preferred to employ the pure active compounds I and II, to which further active compounds against harmful fungi or against other pests, such as insects, arachnids or nematodes, or else herbicidal or growth-regulating active compounds or fertilizers can be added according to need.

Other suitable active compounds in the above sense are in particular fungicides selected from the following groups:
acylalanines, such as benalaxyl, metalaxyl, ofurace, oxadixyl,
amine derivates, such as aldimorph, dodine, dodemorph, fenpropimorph, fenpropidin, guazatine, iminoctadine, spiroxamine, tridemorph,
anilinopyrimidines, such as pyrimethanil, mepanipyrim or cyprodinil,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole,
triticonazole,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, penthiopyrad, picobenzamid, probenazole, proquinazid, pyrifenox, pyroquilon, quinoxyfen, silthiofam, thiabendazole, thifluzamid, thiophanate-methyl, tiadinil, tricyclazole, triforine,
copper fungicides, such as Bordeaux mixture, copper oxychloride, copper hydroxide, copper oxide, (basic) copper sulfate, copper oxychloride sulfate,
nitrophenyl derivatives, such as binapacryl, dinocap, dinobuton, nitrophthal-isopropyl,
phenylpyrroles, such as fenpiclonil or fludioxonil,
sulfur,

other fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, fosetyl-aluminum, iprovalicarb, hexachlorobenzene, mandipropamid, metrafenon, pencycuron, propamocarb, phosphorous acid, phthalide, toloclofos-methyl, quintozene, zoxamide,
strobilurins, such as azoxystrobin, dimoxystrobin, enestroburin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid,
cinnamides and analogous compounds, such as dimethomorph, flumetover or flumorph.

In one embodiment of the mixtures according to the invention, a further fungicide III or two fungicides III and IV are added to the compounds I and II.

Preference is given to mixtures of the compounds I and II with a component III. Particular preference is given to mixtures of the compounds I and II.

The compound I and the compound II are usually applied in a weight ratio of from 100:1 to 1:100, preferably from 20:1 to 1:20, in particular from 10:1 to 1:10.

The components III and, if appropriate, IV are, if desired, added in a ratio of 20:1 to 1:20 to the compound I.

Depending on the type of compound and of the desired effect, the application rates of the mixtures according to the invention are from 5 g/ha to 1000 g/ha, preferably from 50 to 900 g/ha, in particular from 50 to 750 g/ha.

Correspondingly, the application rates for the compound I are generally from 1 to 1000 g/ha, preferably from 10 to 900 g/ha, in particular from 20 to 750 g/ha.

Correspondingly, the application rates for the compound II are generally from 1 to 1000 g/ha, preferably from 10 to 900 g/ha, in particular from 40 to 500 g/ha.

In the treatment of seed, application rates of mixture are generally from 1 to 1000 g/100 kg of seed, preferably from 1 to 750 g/100 kg, in particular from 5 to 500 g/100 kg.

The method for controlling harmful fungi is carried out by the separate or joint application of the compound I and the compound II or of the mixtures of the compound I and the compound II is carried out by spraying or dusting the seeds, the plants or the soil before or after sowing of the plants or before or after emergence of the plants.

The mixtures according to the invention, or the compounds I and II, can be converted into the customary formulations, for example solutions, emulsions, suspensions, dusts, powders, pastes and granules. The use form depends on the particular intended purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers, such as ground natural minerals (for example kaolins, clays, talc, chalk) and ground synthetic minerals (for example highly disperse silica, silicates); emulsifiers, such as nonionogenic and anionic emulsifiers (for example polyoxyethylene fatty alcohol ethers, alkylsulfonates and arylsulfonates), and dispersants, such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol and nonylphenol, alkylphenyl polyglycol ethers, tributylphenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths, such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to the NMR spectrum).

The following are examples of formulations: 1. Products for dilution with water

A) Water-soluble concentrates (SL)

10 parts by weight of the active compounds are dissolved in water or in a water-soluble solvent. As an alternative, wetters or other auxiliaries are added. The active compound dissolves upon dilution with water.

B) Dispersible concentrates (DC)

20 parts by weight of the active compounds are dissolved in cyclohexanone with addition of a dispersant, for example polyvinylpyrrolidone. Dilution with water gives a dispersion.

C) Emulsifiable concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-dispersible granules and water-soluble granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-dispersible powders and water-soluble powders (WP, SP)

75 parts by weight of the active compounds are ground in a rotor-stator mill with addition of dispersants, wetters and silica gel. Dilution with water gives a stable dispersion or solution of the active compound.

2. Products to be Applied Undiluted

H) Dustable powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and combined with 95.5% of carriers. Current methods are extrusion, spray-drying or the fluidized bed. This gives granules to be applied undiluted.

J) ULV solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier.

However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents are admixed with the compositions according to the invention typically in a weight ratio of from 1:10 to 10:1.

The compounds I and II or the mixtures or the corresponding formulations are applied by treating the harmful fungi or the plants, seeds, soils, areas, materials or spaces to be kept free therefrom with a fungicidally effective amount of the mixture or, in the case of separate application, of the compounds I and II. Application can be carried out before or after infection by the harmful fungi.

The fungicidal action of the compound and of the mixtures can be revealed by the following tests:

The active compounds were prepared separately as a stock solution comprising 25 mg of active compound which was made up to 10 ml using a mixture of acetone and/or DMSO and the emulsifier Uniperol® EL (wetting agent having emulsifying and dispersing action based on ethoxylated alkylphenols) in a volume ratio solvent:emulsifier of 99:1. The mixture was then made up with water to 100 ml. The active compounds or mixtures were mixed or diluted with water to the desired concentration.

Use example—activity against net blotch of barley caused by Pyrenophora teres, 1 day protective application

Leaves of potted barley seedlings of the cultivar “Hanna” were sprayed to runoff point with an aqueous suspension having the concentration of active compound stated below. 24 hours after the spray coating had dried on, the test plants were inoculated blotch pathogen. The test plants were then placed in a greenhouse at temperatures between 20 and 24° C. and 95 to 100% relative atmospheric humidity. After 6 days, the extent of the development of the disease was determined visually in % infection of the entire leaf area.

The visually determined values for the percentages of infected leaf areas were converted into efficacies in % of the untreated control:

The efficacy (E) is calculated as follows using Abbot's formula:
E=(1−α/β)·100
α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants are not infected.

The expected efficacies of the mixtures of active compounds were determined using Colby's formula (Colby, S. R. “Calculating synergistic and antagonistic responses of herbicide combinations”, Weeds, 15, pp. 20-22, 1967) and were compared with the observed efficacies.

Colby's formula:
E=x+y−x·y/100
E expected efficacy, expressed in % of the untreated control, when using the mixture of the active compounds A and B at the concentrations a and b
x efficacy, expressed in % of the untreated control, when using active compound A at the concentration a

y efficacy, expressed in % of the untreated control, when using active compound B at the concentration b

TABLE A
individual active compounds

| | | Concentration | |
|---|---|---|---|
| | | of active | Efficacy in |
| | | compound in | % of the |
| | Active compound/ | the spray | untreated |
| Example | mixing ratio | liquor [ppm] | control |
| 1 | control (untreated) | — | (88% infection) |
| 2 | I | 5 | 72 |
| 3 | IIB-35 | 20 | 55 |
| | | 5 | 0 |
| | | 1.25 | 0 |
| 4 | IIB-37 | 20 | 20 |
| | | 5 | 0 |
| | | 1.25 | 0 |
| 5 | IIB-41 | 20 | 20 |
| | | 5 | 0 |
| | | 1.25 | 0 |

TABLE B
mixtures according to the invention

| | Mixture of active compounds | | |
|---|---|---|---|
| | Concentration | Observed | Calculated |
| Example | Mixing ratio | efficacy | efficacy*) |
| 6 | I + IIB-35 | 92 | 72 |
| | 5 + 1.25 ppm | | |
| | 4:1 | | |
| 7 | I + IIB-35 | 94 | 72 |
| | 5 + 5 ppm | | |
| | 1:1 | | |
| 8 | I + IIB-35 | 100 | 87 |
| | 5 + 20 ppm | | |
| | 1:4 | | |
| 9 | I + IIB-37 | 92 | 72 |
| | 5 + 1.25 ppm | | |
| | 4:1 | | |
| 10 | I + IIB-37 | 92 | 72 |
| | 5 + 5 ppm | | |
| | 1:1 | | |
| 11 | I + IIB-37 | 97 | 77 |
| | 5 + 20 ppm | | |
| | 1:4 | | |
| 12 | I + IIB-41 | 92 | 72 |
| | 5 + 1.25 ppm | | |
| | 4:1 | | |
| 13 | I + IIB-41 | 97 | 72 |
| | 5 + 5 ppm | | |
| | 1:1 | | |
| 14 | I + IIB-41 | 100 | 77 |
| | 5 + 20 ppm | | |
| | 1:4 | | |

*)Efficacy calculated using Colby's formula

The test results show that, by virtue of strong synergism, the mixtures according to the invention are considerably more effective than had been predicted using Colby's formula.

1. A fungicidal mixture for controlling harmful fungi, which mixture comprises
1) the triazolopyrimidine derivative of the formula I 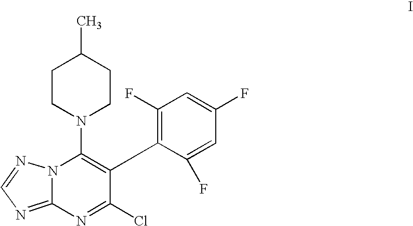
and
2) at least one biphenylamide of the formula II 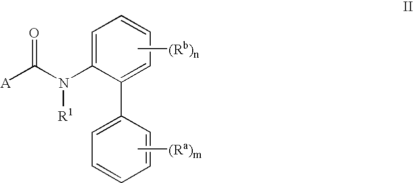
in which the variables are as defined below:
A is oxathiinyl or 5-membered heteroaryl which contains one to four nitrogen atoms or one to three nitrogen atoms and/or one sulfur or oxygen atom, where A may be substituted by one or two identical or different substitutents R;
R is halogen, cyano, C₁-C₄-alkyl, C₁-C₂-haloalkyl, C₁-C₄-alkoxy, C₁-C₄-alkylthio;
R¹ is hydrogen, C₁-C₄-alkyl, C₁-C₄-alkylcarbonyl or a group A which is attached via carbonyl;
R^{a},R^{b} independently of one another are halogen, cyano, C₁-C₄-alkyl, C₁-C₄-haloalkyl, C₁-C₆-alkoxycarbonyl, C₁-C₄-alkoxy, C₁-C₄-haloalkoxy, C₁-C₄-alkylthio, C₁-C₄-alkylcarbonyl, formyl, C₁-C₄-alkylene or C₂-C₄-alkenylene which links two adjacent carbon atoms;
m is 0, 1, 2, 3, 4 or 5, where the radicals R^{a} can be identical or different if n is greater than 1
n is 0, 1 or 2; where the radicals R^{b} can be identical or different if n is 2;
in a synergistically effective amount.

2. The fungicidal mixture according to claim 1 comprising a compound of the formula IIA 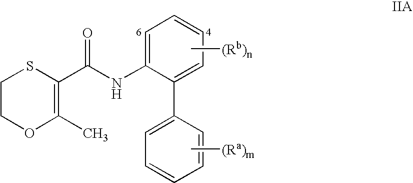
in which (R^{a})ₘ and (R^{b})ₙ are as defined in claim 1.

3. The fungicidal mixture according to claim 1 comprising a compound of the formula IIB 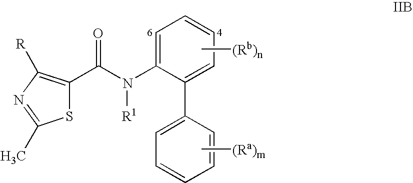
in which the variables are as defined in claim 1.

4. The fungicidal mixture according to claim 1 comprising a compound of the formula IIC 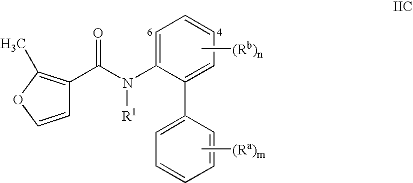
in which the variables are as defined in claim 1.

5. The fungicidal mixture according to claim 1 comprising a compound of the formula IID 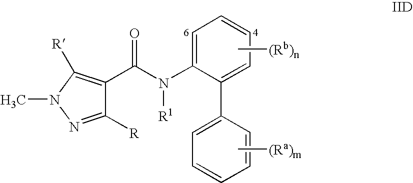
in which the variables are as defined in claim 1 and R¹ corresponds to a group R.

6. The fungicidal mixture according to any of claims 1 to 5 comprising the compound of the formula I and the biphenylamide in a weight ratio of from 100:1 to 1:100.

7. A composition comprising a liquid or solid carrier and the mixture according to claim 1.

8. A method for controlling phytopathogenic harmful fungi which comprises treating the fungi, their habitat or the seed, the soil or the plants to be protected against fungal attack with an effective amount of the compound I and the compound II according to claim 1.

9. The method according to claim 8, wherein the compounds I and II according to claim 1 are applied simultaneously, that is jointly or separately, or in succession.

10. The method according to claim 8, wherein the compounds I and II are/is applied in an amount of from 5 g/ha to 1000 g/ha.

11. The method according to claim 8, wherein the compounds I and II are/is applied in an amount of from 1 to 1000 g/100 kg of seed.

12. Seed comprising the mixture according to claim 1 in an amount of from 1 to 1000 g/100 kg.

13. The use of the compounds I and II according to claim 1 for preparing a compostion suitable for controlling harmful fungi.
